(19) United States
(12) Patent Application Publication
(10) Pub. No.: US 2026/0132994 A1
(43) Pub. Date: May 14, 2026

(54) METHODS FOR ENERGY STORAGE AND RELEASE

(71) Applicant: OMC Hydrogen, Inc., Louisville, CO (US)

(72) Inventors: Kent Warren, Broomfield, CO (US); Bharath Tata, Boulder, CO (US); Britt Boughey, Ventura, CA (US)

(73) Assignee: OMC Hydrogen, Inc., Louisville, CO (US)

(21) Appl. No.: 19/384,943

(22) Filed: Nov. 10, 2025

Related U.S. Application Data
(60) Provisional application No. 63/718,465, filed on Nov. 8, 2024.

(51) Int. Cl. F28D 20/00; C09K 5/06

(52) U.S. Cl. CPC F28D 20/0056; F28D 20/003; C09K 5/063

(57) ABSTRACT

Various aspects of this disclosure relate to a method of using an active material, made of earth-abundant materials, for energy storage & release. In some embodiments, as the material is heated, it undergoes a phase change at high temperatures that releases oxygen and stores energy in the form of chemical bonds. This material can store and release energy quickly and on-demand through a reduction/oxidation cycle.

### CROSS-REFERENCE TO RELATED APPLICATIONS

This patent application claims priority to U.S. Provisional Patent Application No. 63/718,465, filed 8 Nov. 2024, which is incorporated by reference in its entirety.

### BACKGROUND OF CERTAIN ASPECTS OF THE DISCLOSURE

Thermal energy storage (TES) is a powerful strategy for increasing energy efficiency by reducing losses caused by supply-demand discrepancies. TES allows for consistent energy supply throughout an inconsistent energy generation cycle (e.g., the diurnal variation of energy production via solar panels). Thermal energy storage can be accomplished by using sensible heat. Many technologies exist for room-temperature TES, but high-temperature energy storage is still an open field.

### BRIEF SUMMARY OF SOME ASPECTS OF THE DISCLOSURE

The present disclosure relates to a method of using an active material made of earth-abundant ingredients for thermochemical energy storage and release. In some embodiments, the material may comprise a mixture or solid solution of several metal oxides containing, for example, iron, cobalt, and/or aluminum, the composition of which is intentionally designed to store sensible, latent, and thermochemical energy.

In some embodiments, the heat stored in the active material can be derived from both a nonstoichiometric reduction reaction and a stoichiometric solid-solid phase transition. The combination of heat storage via these different mechanisms offers the potential for a superlative high temperature thermal energy storage material.

In some embodiments, the temperature at which the solid-solid phase transition occurs and, consequently, the temperature at which heat can be later dispatched, is tunable or adjustable according to the composition of the active material.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

The preferred and other embodiments are disclosed in association with the accompanying drawings in which:

FIG. 1 is a graph of example measurements of heat stored in the solid-solid phase transition from a mixture of hematite and corundum to a spinel solid solution of magnetite, corundum, and hercynite in accordance with aspects of the present disclosure.

FIG. 2 shows phase stability of example systems in accordance with aspects of the present disclosure.

FIG. 3 is a diagram of example reduction/oxidation cycling of the active material in accordance with aspects of the present disclosure.

### DETAILED DESCRIPTION

In the following description, for the purposes of explanation, numerous specific details are set forth to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with some other implementations as well. Similarly, however, no single feature or features of any described implementation should be considered essential to the invention as some implementations of the invention may omit such features.

A solid-gas redox reaction is a thermochemical reaction that can be used in thermal energy storage applications. The redox reaction stores heat energy by using reversible chemical reactions. When exposed to heat, a material changes its oxidation state and stores thermal energy as chemical potential that can be released when the reaction is reversed (oxidation and reduction). This process can be achieved using metal oxides which can evolve oxygen at high temperature and replenish their oxygen deficiency when cooled down.

The disclosed technology relates to methods of using active material made of earth-abundant materials for energy storage and release. In some embodiments, the active material may be used to facilitate redox chemistry-driven thermochemical fuel production. In some embodiments, the active material may be a mixture of several metal oxides containing iron, cobalt, and/or aluminum, the composition of which is intentionally designed to store both sensible, latent, and thermochemical energy. Other metal oxides are contemplated.

In some embodiments, the heat stored in the active material can be derived from both a nonstoichiometric reduction reaction and a stoichiometric solid-solid phase transition. The combination of heat storage via these different mechanisms offers the potential for a superlative high temperature thermal energy storage material.

Importantly, the temperature at which the solid-solid phase transition occurs and, consequently, the temperature at which heat can be later dispatched, is tunable or adjustable according to the composition of the material.

In some embodiments, the active material can store and release energy quickly and on-demand through a reduction/oxidation cycle. As the active material is heated either under a reducing environment (e.g., made of nitrogen, argon, or another inert gas or hydrocarbon gases such as methane) or oxidizing environment (e.g., air), the active material undergoes a stoichiometric solid-solid phase change that releases oxygen and stores energy in the form of chemical bonds. Thereafter, the material can store additional energy through further nonstoichiometric reduction, in which only a portion of the material's oxygen is removed. In either event, the energy can remain stored for long durations before an oxidant (typically air, oxygen, or another O₂-containing molecule like steam or CO₂) is passed over the material. The material absorbs this oxygen while releasing heat, which would be harnessed for useful purposes, such as generating electrical power via a turbine, providing high temperature industrial heat, and mitigating the intermittency of renewable energy to power a thermochemical process during periods of renewable energy non-availability. The ability to effectively transport fuel is useful for providing emission-less, high-quality industrial heat to areas with minimal renewables or high sensitivity to emissions.

For purposes of this disclosure, the “active material” (also referred to as a “metal oxide”) may be a mixture of oxygen and metals (e.g., iron, cobalt, and aluminum) in different oxidation states. The preferred form (or chemical composition) changes based on the temperature at which heat is to be dispatched. The preferred temperatures where the metal oxide could exist range widely, from ambient (for storage and transportation) up to high temperatures (reaching as high as 1800° C.).

In some embodiments, the active material may consist of a mixture of iron aluminates, including corundum (Al₂O₃), hematite (Fe₂O₃), hercynite (FeAl₂O₄), and magnetite (Fe₃O₄). The exact composition may vary based on temperature and production method.

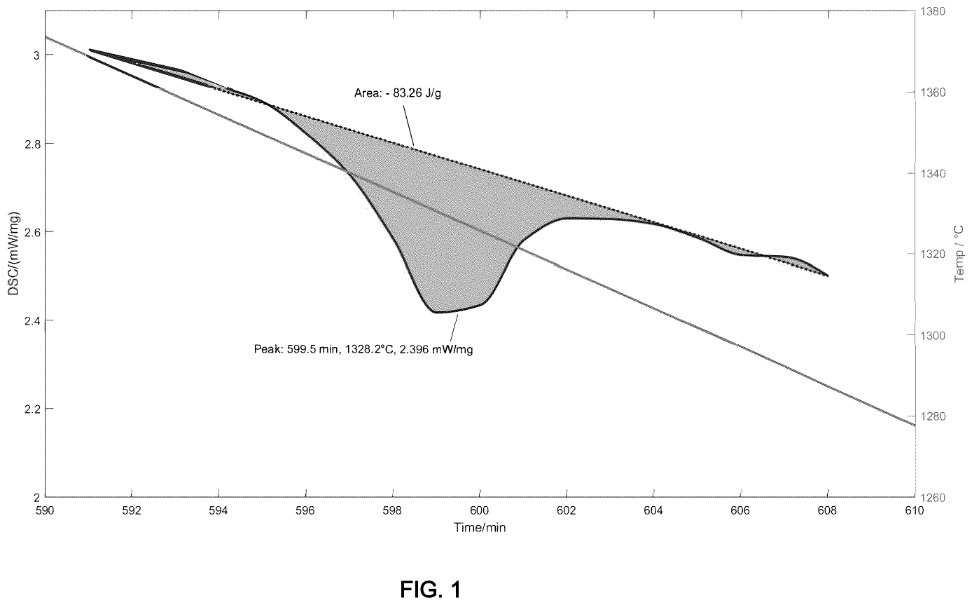

For a representative composition, i.e., Fe33A167 (33 wt. % iron and 67 wt. % aluminum), combined thermogravimetric and differential scanning calorimetric characterization demonstrates the potential for a material capable of extremely high energy densities. An exemplary measurement of the heat stored in the solid-solid phase transition from a mixture of hematite and corundum to a spinel solid solution of magnetite, corundum, and hercynite is shown in FIG. 1. In addition, sensible heat can be stored as the material is heated from a lower to a higher temperature. To determine the contribution of sensible heat, heat capacities were estimated without direct measurement by referencing literature values for the compounds that make up the disclosed active material at different temperatures. Heat capacities as functions of temperature for corundum, hematite, and magnetite were calculated using Shomate equation data from NIST-JANAF Thermochemical Tables, Fourth Edition, J Phys Chem Ref Data, 1998. Heat capacity of hercynite as a function of temperature, on the other hand, was calculated via linearization of 0 GPa data (1000 to 1800 K) (from table 3 from Verma, H., Tripathi, M. K., and Verma, M. L., “Thermodynamic Properties of Hercynite (FeAl₂O₄) for Thermochemical Water Splitting Applications: A First-Principles Approach,” Journal of Solid State Chemistry, Vol. 339, 2024, p. 124928. https://doi.org/10.1016/j.jssc.2024.124928. Taking the assumption that the system behaves like an ideal mixture with minimal interactions between components and low Gibbs energy of mixing, the estimated heat capacity of the bulk material can be calculated using weighted means of Cₚ's of the constituents, in line with Kopp's law and the Rule of Mixtures. The means were weighted by the concentrations of the constituents as shown below. Assumptions were for concentrations based on mass conservation of the Al and Fe atoms in the bulk material.

### Below Phase Transition

Corundum:hematite molar ratio=67:33, equivalent to the Al:Fe ratio of the tested material

### Above Phase Transition

Magnetite:hercynite:corundum molar ratio=5.33:17:16.5, Al:Fe ratio of 67:33 while balancing the hercynite and corundum concentrations. Solid-solid phase change materials have been developed that can operate at temperatures between 100° and 1500° C. For example, magnesium-manganese oxide materials have been shown to demonstrate energy densities of 1070 kJ/kg when considering both the reaction enthalpy from the stoichiometric solid-solid phase transition and the sensible heat required to heat from 1000° C. to 1500° C. However, these magnesium-manganese oxide materials are incapable of storing additional heat via further nonstoichiometric reduction. When applying the same methodology to the iron aluminate Fe33A167 composition disclosed herein (i.e., without including additional energy storage via further nonstoichiometric reduction), an energy density of 735 kJ/kg was obtained as shown in Table 1 below.

TABLE 1
High-temperature enthalpy comparison including sensible heat

| | ΔH₁ (kJ/kg) | ΔH_{Rxn} (kJ/kg) | ΔH₂ (kJ/kg) | ΔHₜₒₜ (kJ/kg) |
|---|---|---|---|---|
| OMC | 286 | 107 ± 11 | 342 | 735 ± 11 |
| Redoxblox*^{†} | 358.8-479.1 | 565.3-590.9 | | 924.1-1070 |

*Two sensible heats are presented: one between 1000° C. and the phase change (ΔH₁), and one between the phase change and 1500° C. (ΔH₂). RedoxBlox combines these into one number (shown as ΔH₁).
^{†}RedoxBlox advertises a thermal capacity of 1500 kJ/kg.

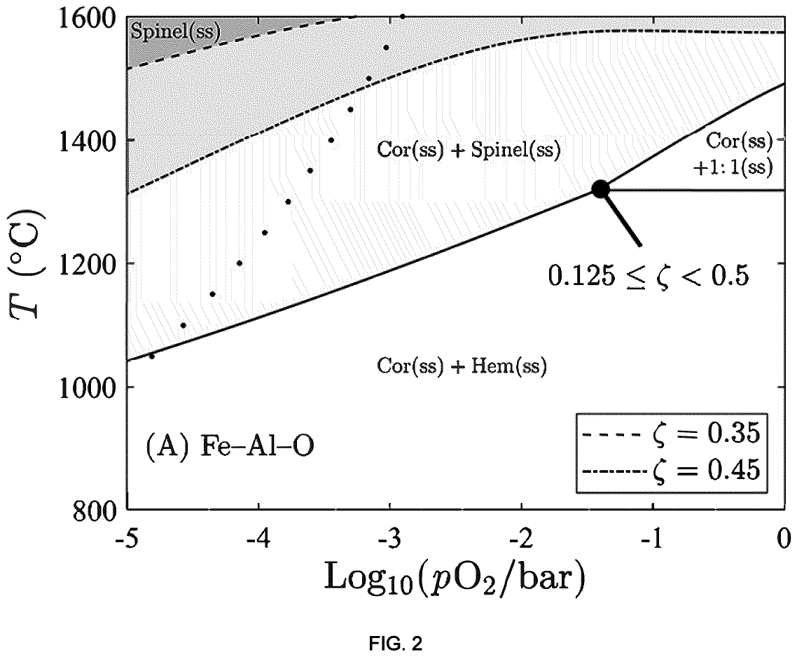

FIG. 2 presents the results of Fact-Sage free energy minimization calculations for select iron aluminate and cobalt-iron aluminate compositions. As shown in FIG. 2, the region 102 indicates the spinel phase, the region 104 indicates the equilibrium of spinel and corundum phases, and the regions 106 represent the conditions in which the iron aluminates are fully oxidized, as evidenced by the presence of hematite. The solid line 108 between the regions 104 and 106—which is of primary interest and is hereafter referred to as the solid-solution phase boundary—remains constant over a wide range of iron cation compositions (e.g., from 0.125 to 0.5).

The Co—Fe—Al—O, on the other hand, exhibits similar behavior, although only three phases are present: a solid solution of spinels (i.e., CoAl₂O₄, Co₃O₄, FeAl₂O₄, and Fe₃O₄), a solid solution of corundum, and a solid solution of hematite. Here, both phase boundaries—including that between the regions 104 and 106—change as a function of cobalt cation composition, shifting towards lower temperatures and higher oxygen partial pressures as ζ increases. Thus, the introduction of cobalt in iron aluminates reduces the temperature required for the transition from the oxidized state into a reduced one.

This ability to tune the temperature at which highly-energy dense, latent heat may be dispatched unlocks transportability of sustainable, yet often intermittent, sources of high-quality heat (e.g., concentrated solar radiation) and reduces the need for site-integrated thermal energy storage for industrial heat applications.

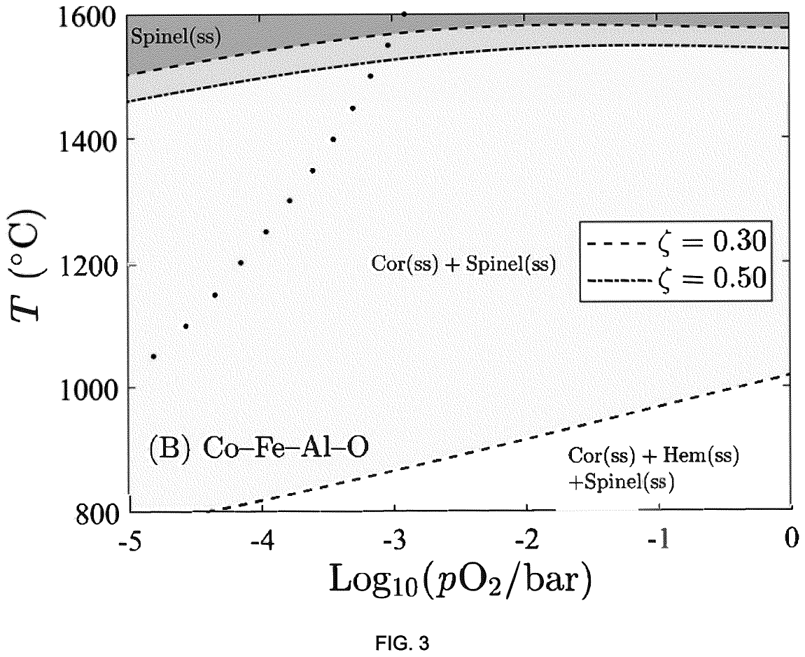

FIG. 3 is a diagram of an embodiment the “redox” (reduction/oxidation) cycling of the active material. In a high-temperature environment, the active material undergoes a phase change, releasing pure oxygen and storing energy in chemical bonds. A relevant range can be from 600 degrees Celsius to 1400 degrees Celsius. Another relevant range can also be from 600 degrees Celsius to 1800 degrees Celsius. When the oxygen-deficient metal oxide is then exposed to an oxidizing atmosphere at high temperature, heat is released as oxygen is absorbed.

To show embodiments of the thermochemical reactions, chemical formulas are:

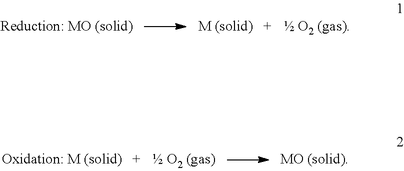

3. where M represents the oxygen-deficient metal oxide and MO represents the oxygen-rich metal oxide. The interaction itself can be both stoichiometric and non-stoichiometric.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method of energy storage and release, comprising:
heating active material under an oxidizing or reducing environment;
undergoing a solid-solid phase change at a high temperature;
releasing oxygen;
storing energy in the form of chemical bonds within the environment;
passing an oxidant over the active material;
absorbing the oxygen with the active material;
releasing heat for a predetermined use from the environment.

2. The method of claim 1, further comprising:
adjusting a temperature at which the solid-solid phase transition occurs;
and adjusting a temperature at which the heat is released based on a composition of a spinel in the phase change.

3. The method of claim 1, wherein the active material is a metal oxide.

4. The method of claim 3, wherein the metal oxide is comprised of at least one of iron, cobalt, and aluminum.

5. The method of claim 4, wherein the metal oxide is a mixture or solid solution of one of the following cobalt-iron aluminates:corundum (Al₂O₃), hematite (Fe₂O₃), cobalt ferrite (CoFe₂O₄), hercynite (FeAl₂O₄), and magnetite (Fe₃O₄).

6. The method of claim 1, wherein the oxidant is air, oxygen, steam or CO₂.

7. The method of claim 6, wherein the inert gas is nitrogen or argon.

8. The method of claim 1, wherein the reducing environment is made of hydrocarbon gases.

9. The method of claim 1, wherein the hydrocarbon gas is methane.

10. The method of claim 1, wherein the predetermined use is generating electrical power via turbine.

11. The method of claim 1, wherein the predetermined use is providing high temperature industrial heat.

12. The method of claim 1, wherein the predetermined use is mitigating the intermittency of renewable energy to power a thermochemical process during periods of renewable energy non-availability.

13. The method of claim 1, wherein the predetermined use is providing emissionless, high-quality industrial heat to areas with minimal renewables or high sensitivity to emissions.

14. The method of claim 2, wherein the temperature at which solid state phase transition ranges from 600 degrees Celsius to 1400 degrees Celsius.

15. The method of claim 2, wherein the temperature at which heat is released ranges from 600 degrees Celsius to 1800 degrees Celsius.
